(19) United States
(12) Patent Application Publication
(10) Pub. No.: US 2006/0274857 A1
(43) Pub. Date: Dec. 7, 2006

(54) RFID receiver with digital down conversion

(76) Inventor: Lihu M. Chiu, Arcadia, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/143,250

(22) Filed: Jun. 2, 2005

(51) Int. Cl. H04L 27/00

(52) U.S. Cl. 375/316

(57) ABSTRACT

An RFID receiver uses digital down conversion to facilitate determination of the frequency of a radio frequency signal from an RFID tag and to facilitate demodulation of the signal. Two analog-to-digital converters can be configured to undersample a signal from the RFID tag. Adjacent pairs of samples can be used to determine the frequency of the radio frequency signal. The digital signal resulting from undersampling by one of the two analog-to-digital signals defines a frequency down converted signal that can be used for demodulation. Frequency down conversion facilitates the use of a field programmable gate array (FPGA) and/or a digital signal processor (DSP) for determination of the frequency and demodulation, thus eliminating costly analog components while increasing the flexibility of the receiver.

### TECHNICAL FIELD

The present invention relates generally to radio frequency identification (RFID). The present invention relates more particularly to an RFID receiver that is configured to perform digital down conversion on a radio frequency signal from an RFID tag.

### BACKGROUND

RFID tags for identifying goods are well known. They can be applied to either the goods themselves or to packaging for the goods. RFID tags typically comprise an integrated circuit or chip and an antenna coupled to the chip. Information regarding the goods is stored upon the chip. For example, this information can include identification information, manufacturing information (such as what manufacturing processes have already been performed and/or what manufacturing process is to be performed next), customer information, and/or shipping information. RFID tags can be formed upon adhesive labels to facilitate their application to the goods or packaging.

The antenna typically comprises a plurality of conductive traces formed upon a substrate, such as the label. The antenna facilitates communication between the chip and an RFID reader and/or writer. Information is first programmed onto the chip with an RFID writer. Information is subsequently read from an RFID chip by interrogating the chip with a reader. The reader transmits an interrogation signal that is picked up by the antenna and is then communicated to the chip. The chip subsequently responds by communicating an information signal to the antenna that is then backscattered to the RFID reader.

The information signal can be read by either a hand-held RFID reader or a stationary RFID reader. Hand-held RFID readers can be used in warehouses, for example. In a warehouse, an RFID reader can be used to locate a desired item (having an RFID tag) from among many similar items.

Stationary RFID readers can be used in manufacturing processes. For example, they can be used to determine what manufacturing process is to be performed next on an item passing along a conveyor. Thus, an RFID reader can be used to determine what color an item is to be painted or what accessories are to be added thereto. Such information can be used to determine where in a manufacturing plant the item goes next and thus facilitates the automation of manufacturing processes.

Stationary RFID readers can also be used to verify RFID tags. That is, RFID tags can be interrogated by an RFID verifier to verify their functionality and/or content. Proper functionality may be verified as part of the process for manufacturing RFID tags. Content verification can be performed after an RFID tag has been programmed.

One problem with contemporary RFID readers, whether hand-held or stationary, is that they tend to be costly. One reason that RFID readers tend to be costly is that the receivers thereof use a number of analog components. An analog down converter is one example of such an analog component. Since analog components tend to increase the costs of RFID readers, it is often desirable to replace such components with digital processing devices.

Another problem with RFID applications is that the carrier frequency can be different in other countries. Thus, the frequency to be used by RFID tag verifiers can be country dependent. Knowing the carrier frequency of the tag being read is necessary to insure that regulatory guidelines are not violated by the verification device.

In addition to regulatory compliance concerns, there is also the issue of cross channel separation. In order for an RFID tag that is not being verified not to interfere with another RFID tag's transmitted signals and thus be misinterpreted by other readers in the proximity of the verifications device, the verifier needs to know the exact frequency of the carriers of the existing systems prior to illuminating the verification device's own field. Therefore, it can be important to know the carrier frequency of the tag being read. This is particularly true in situations where nearby tags of a plurality of different frequencies are transmitting at the same time.

This may be the case, for example, in an RFID tag manufacturing facility where there are several adjacent test lines for RFID tag verification. If the channel frequencies of the environment tag is known, then transmissions from other reader/transmitters on adjacent bands and adjacent channel frequencies can be filtered out, and not interfere with the verification reading of the target tag. Thus, it is desirable to be able to determine the carrier frequency of an RFID system environment.

Another problem is being able to remove adjacent bands during downconversion using standard digital filtering methods. Although an antenna has some frequency selectivity associated, it is often not enough rejection to allow for the high signal to noise ration required by a verification system. If ranging or backscatter intensity measurements are desired, it is necessary to maximize the signal to noise ratio. Knowing the specific frequency that is in the “field of view” of the verification antenna, will allow the software to determine which frequencies to filter out. It is generally not enough to only bandpass filter the frequency of interest in an undersampled system.

### BRIEF SUMMARY

Systems and methods are disclosed herein to provide a receiver for a radio frequency identification (RFID) reader that uses digital down conversion to facilitate determination of the frequency of a radio frequency signal from an RFID tag and/or to facilitate demodulation of the signal. Undersampling can be used to effect such digital down conversion. By undersampling at pairs of nearby points in a waveform, frequency determination can be effected.

More particularly, in accordance with one embodiment of the present invention, two analog-to-digital converters can be configured so as to effect undersampling of a signal from an RFID tag. Sampling with the two analog-to-digital converters can be clocked such that nearby pairs of points define samples that can be used to determine the frequency of the radio frequency signal. The digital signal resulting from undersampling by one (or optionally both) of the two analog-to-digital-converters defines a frequency down converted signal that can be used for demodulation.

In accordance with one embodiment of the present invention, at least one low noise amplifier receives a radio frequency signal from an RFID tag. Two analog-to-digital converters receive an amplified radio frequency signal from the low noise amplifier(s). A clock provides a timing signal to each of two delays. Each delay provides a delayed clock signal to a dedicated one of the two analog-to-digital converters. The two delayed clock signals are offset in time with respect to one another to facilitate the sampling of pairs of nearby points of the radio frequency signal from the RFID tag.

Frequency down conversion facilitates the use of a field programmable gate array (FPGA) and/or a digital signal processor (DSP) for determination of the frequency and for demodulation, thus eliminating costly analog components while increasing the flexibility of the receiver.

The use of digital down conversion eliminates analog components. It also increases the flexibility of the receiver by more readily facilitating frequency determination and/or demodulation by digital circuitry that can be re-programmed or otherwise re-configured to accommodate different or addition desired functionality. For example, such digital circuitry can readily accommodate changes in the modulation method used.

This invention will be more fully understood in conjunction with the following detailed description taken together with the following drawings.

### BRIEF DESCRIPTION OF THE DRAWINGS

FIG. 1 is chart showing a simplified waveform of a radio frequency signal from an RFID tag and also showing frequency down conversion resulting from undersampling thereof;

FIG. 2 is a chart showing the simplified waveform of FIG. 1 and also shown a plurality of pairs of undersampling points, such as those that may be used to determine the frequency of the radio frequency signal;

FIG. 3 is a chart showing the waveforms of two offset (with respect to one another) clock signals, such as those that can be used to operate two analog-to-digital converters according to at least one embodiment of the present invention;

FIG. 4 is a block diagram showing down conversion, frequency determination, and demodulation circuitry according to one exemplary embodiment of the present invention, wherein one low noise amplifier is used; and

FIG. 5 is a block diagram showing down conversion, frequency determination, and demodulation circuitry according to another exemplary embodiment of the present invention, wherein two low noise amplifiers are used.

Embodiments of the present invention and their advantages are best understood by referring to the detailed description that follows. It should be appreciated that like reference numerals are used to identify like elements illustrated in one or more of the figures.

### DETAILED DESCRIPTION OF THE INVENTION

An RFID receiver uses direct digital down conversion to facilitate determination of the frequency of a radio frequency signal from an RFID tag and to facilitate demodulation of the signal. The receiver can be used in either an RFID tag verifier or an RFID reader. RFID tag verifiers are used to check the operability and programming of RFID tags, typically as part of the manufacturing process thereof. RFID readers are used to scan products, such as in retail stores and warehouses.

According to one embodiment of the present invention, an analog-to-digital converter is configured so as to undersample a radio frequency signal from an RFID tag. Undersampling, as discussed in detail below, results in frequency down conversion of the RFID signal. As those skilled in the art will appreciate, down conversion provides a lower frequency signal that can more readily be processed.

According to one embodiment of the present invention, two analog-to-digital converters can be configured such that both undersample a signal from the RFID tag and such that samples are taken by both analog-to-digital converters at approximately the same, but different, times. The resulting pairs of adjacent samples can be used to determine the frequency of the radio frequency signal. The digital signal resulting from undersampling by one (or optionally both) of the two analog-to-digital converters defines a frequency down converted signal that can be used for demodulation.

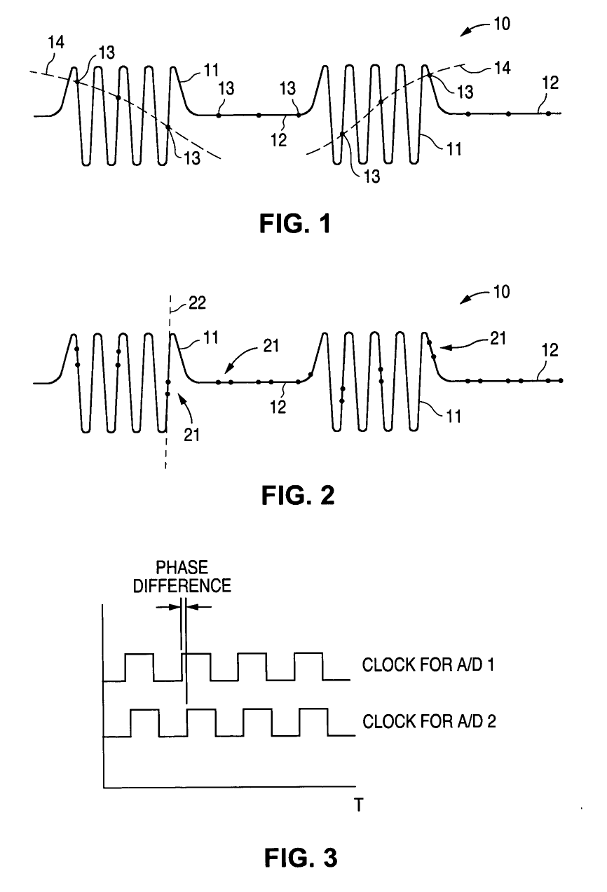

Referring now to FIG. 1, a radio frequency signal 10 from an excited RFID tag comprises a series of pulses 11 and non-pulse areas 12 according to on-off keying (OOK) modulation. Thus, pulses 11 may represent digital ones and non-pulse areas 12 may represent digital zeros, for example. The pulses are at a carrier frequency, typically of approximately 900 MHz. As mentioned above, it is generally desirable to reduce the frequency of the pulses (the carrier frequency), so as to better facilitate processing of the signal.

According to one aspect of the present invention, down conversion of the carrier frequency is accomplished by undersampling a radio frequency signal from an RFID tag. Such undersampling may be performed at a frequency of approximately 40 MHz, for example. Due to the use of undersampling, samples 13 are not taken frequently enough to accurately define the sampled radio frequency RFID tag signal. Rather, the samples are taken at well below the Nyquist rate and thus result in aliasing.

This aliasing provides a down converted representation of the RFID tag signal that is suitable for demodulation. The down converted representation is a lower frequency signal or down converted signal 14. More particularly, down converted signal 14 can be demodulated using OOK demodulation techniques to obtain digital data therefrom. Down converted signal 14 can similarly be demodulated using other demodulation techniques, such as BPSK, if desired.

Referring now to FIG. 2, an optional method for determining the frequency of the RFID tag radio frequency carrier signal that defines pulses 11 is discussed. This method may be practiced in combination with down conversion for use in demodulation, as described above. Alternatively, this method may be used independently, so as to provide frequency determination without demodulation. Thus, any desired combination of frequency determination and demodulation may be performed.

It is sometimes necessary to determine the frequency of an RFID tag's output. This may be the case, for example, when RFID tag verifiers have been provided to RFID tag manufacturers in a plurality of different countries, wherein the output frequencies of the tags is different in each country. Rather than rely upon an operator to know and correctly enter the RFID tag frequency, it is advantageous to automatically sense the frequency of the RFID tag's output signal.

According to one aspect of the present invention, the frequency of an RFID tag signal 10 can be determined by repeatedly undersampling pairs 21 of nearby points on the carrier waveform that are very close to one another in time. The sample points of such sample pairs 21 can be between approximately 5 pSec and 100 pSec apart from one another for a carrier frequency of approximately 900 MHz, with higher resolution typically being used at higher frequencies, such as 30 pSec for 2.4 GHz and 5 pSec at 24 GHz, for example.

The slope of a line joining the two points of at least one of such pairs 21 can be used to determine the frequency of the carrier of an RFID tag. The slope of the line having the greatest slope of all such lines is proportional to the frequency of the carrier signal. For example, line 22 is the line between adjacent sample points of FIG. 3 that has the highest slope. Joining any other pair of sample points results in a line having less slope. The slope of line 22 can be used to determine, at least with some degree of accuracy, the carrier frequencies within the “field of view” of an RFID reader or verifier.

Referring now to FIG. 3, exemplary clock signals for use in performing such paired undersampling are shown. Two clock signals, one for each of two different analog-to-digital converters, have a phase difference that results in the desired time offset between sample points of a pair 21. The smaller this phase difference, the more accurate the determination of frequency. Of course, making the phase difference arbitrarily small is limited by the quality of the electronics involved in the sampling process, e.g., the amount of jitter in the clocks used and the amount of undesirable (unstable) phase delays introduced into the clock and sampling circuitry. One way to mitigate undesirable relative phase jitter among the clock signals is to introduce controlled and stable delays into two outputs from a single clock that is used to provide the two offset clock signals, as discussed in detail below.

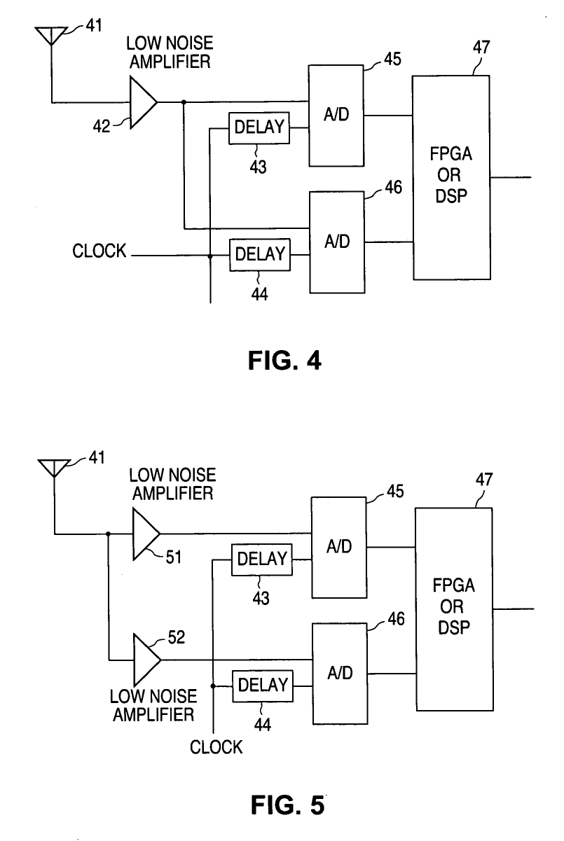

Two exemplary embodiments of the present invention are illustrated in FIGS. 4 and 5. However, such illustration and the related description is by way of example only, and not by way of limitation. Those skilled in the art will appreciate that other embodiments are likewise suitable for practicing the various aspects of the present invention.

Referring now to FIG. 4, an RFID tag's radio frequency signal is received by an antenna of an RFID receiver. The received radio frequency signal is amplified by a low noise amplifier 42. The amplified signal is provided to two analog-to-digital converters 45 and 46 for conversion to a lower frequency signal via a down conversion process.

A clock provides a timing signal to each of two different delays 43 and 44. Delays 43 and 44, in combination with the inherent propagation delays of other circuitry though which the clock signals are communicated, provide delays that result in the phase difference shown in FIG. 3. It is worthwhile to note that at least one of delays 43 and 44 can be a zero delay. That is, it can provide either minimal or no delay to the clock signal provided thereto. The important point is that delays 43 and 44, in combination with other circuitry, provide delays that result in a desired phase difference.

The output of analog-to-digital converter 45 is a series of digital signals corresponding to amplitudes of the RFID signal at periodic points in time, as best indicated by sample points 13 in FIG. 1. The output of analog-to-digital converter 46 is a similar series of digital signals corresponding to amplitudes of the RFID signal at slightly different periodic points in time, as indicated by additional sample points of sample pairs 21 in FIG. 2. The output of one of the analog-to-digital converters, such as analog-to-digital converter 46, is effectively a down conversion of RFID signal 10 and can be used for demodulation. The outputs of both analog-to-digital converters 45 and 46 can be used together to determine the frequency of RFID signal 10.

The down converted signal 14 can be used for demodulation of an OOK modulated carrier since the down converted signal 14 has at least some amplitude in the same places that the carrier signal 10 has amplitude (at the pulses) and goes to zero in the same places as does the carrier signal 10. Thus, where there are pulses 11 in the carrier signal 10, there will be pulses in the lower frequency down converted signal 14 and where there are non-pulse regions 12 in the carrier signal, there will be non-pulse areas in the down converted signal 14.

A field programmable gate array (FPGA), a digital signal processor (DSP), or a combination thereof 47 can be used to perform demodulation and/or frequency determination. The use of such digital processing provides enhanced flexibility. For example, the use of such digital processing makes conversion to a different modulation method simpler. Thus, demodulation by BPSK instead of OOK can be accomplished simply by the reprogramming or reconfiguration of the FPGA and/or DSP, rather than necessitating the replacement of components of the receiver.

Referring now to FIG. 5, according to one alternative embodiment of the present invention two separate low noise amplifiers 51 and 52 can be used to condition the received RFID signal for analog-to-digital conversion. The use of two separate low noise amplifiers 51 and 52 can be advantageous in that the current requirements of analog-to-digital converters 45 and 46 can be more easily met. Thus, the likelihood of undesirable distortions, such as those due to current clipping, is mitigated via the use of two separate low noise amplifiers 51 and 52.

Thus, according to at least one aspect of the present invention, the use of costly analog components is mitigated by using digital down conversion and/or frequency determination. Further, the size and weight of readers utilizing a receiver according to the present invention is reduced. The use of a field programmable gate array (FPGA) and/or a digital signal processor (DSP) for determination of the frequency and demodulation increases the flexibility of the receiver.

Embodiments described above illustrate, but do not limit, the invention. It should also be understood that numerous modifications and variations are possible in accordance with the principles of the present invention. Accordingly, the scope of the invention is defined only by the following claims.

1. An RFID receiver comprising a digital down converter that is configured to undersample a signal from an RFID tag to effect down conversion thereof.

2. The RFID receiver as recited in claim 1, wherein the digital down converter comprises an analog-to-digital converter that is configured to undersample the signal from the RFID tag to effect down conversion thereof.

3. The RFID receiver as recited in claim 1, wherein the digital down converter comprises an analog-to-digital converter that is configured to undersample a signal from an RFID tag having a frequency of approximately 900 MHz at a sample rate of approximately 40 MHz.

4. The RFID receiver as recited in claim 1, wherein the digital down converter comprises an analog-to-digital converter that is configured to undersample a signal from an RFID tag having a frequency of approximately 2.4 GHz at a sample rate of approximately 40 MHz to 120 MHz.

5. The RFID receiver as recited in claim 1, wherein the digital down converter comprises two analog-to-digital converters that are configured to determine a frequency of the signal from the RFID tag.

6. The RFID receiver as recited in claim 1, wherein the digital down converter comprises two analog-to-digital converters that are configured to determine a frequency of the signal from the RFID tag, the two analog-to-digital converters performing sampling at times that are between approximately 5 pSec and approximately 100 pSec different from one another.

7. The RFID receiver as recited in claim 1, wherein the digital down converter comprises two analog-to-digital converters that are configured to determine a frequency of the signal from the RFID tag, the two analog-to-digital converters performing sampling at times that are approximately 5 pSec to 100 pSec different from one another.

8. The RFID receiver as recited in claim 1, wherein:
the digital down converter comprises:
a low noise amplifier configured to receive a radio frequency signal from an RFID tag;
two analog-to-digital converters, each analog-to-digital converter configured to receive an amplified radio frequency signal from the low noise amplifier;
a clock;
two delays, each delay configured to receive a clock signal from the clock and to provide a delayed clock signal to a dedicated one of the two analog-to-digital converters, the two delayed clock signals being offset in time with respect to one another; and
further comprising at least one of a field programmable gate array (FPGA) and a digital signal processor (DSP) configured to receive a digital signal from each of the two analog-to digital converters and to process the digital signals to determine a frequency of the radio frequency signal and to demodulate the radio frequency signal.

9. The RFID receiver as recited in claim 1, wherein:
the digital down converter comprises:
two low noise amplifiers configured to receive a radio frequency signal from an RFID tag;
two analog-to-digital converters, each analog-to-digital converter configured to receive a amplified radio frequency signal from a dedicated one of the two low noise amplifiers;
a clock;
two delays, each delay configured to receive a clock signal from the clock and to provide a delayed clock signal to a dedicated one of the two analog-to-digital converters, the two delayed clock signals being offset in time with respect to one another; and
further comprising at least one of a field programmable gate array (FPGA) and a digital signal processor (DSP) configured to receive a digital signal from each of the two analog-to digital converters and to process the digital signals to determine a frequency of the radio frequency signal and to demodulate the radio frequency signal.

10. The RFID receiver as recited in claim 1, wherein the receiver is configured to demodulate an on-off keying (OOK) radio frequency signal.

11. The RFID receiver as recited in claim 1, wherein the receiver is configured to demodulate a binary phase shift-keying (BPSK) radio frequency signal.

12. The RFID receiver as recited in claim 1, wherein the receiver is configured to define at least a portion of an RFID tag verifier.

13. The RFID receiver as recited in claim 1, wherein the receiver is configured to define at least a portion of a hand held RFID reader.

14. An RFID receiver comprising a digital down converter that is configured to undersample a signal from an RFID tag to effect down conversion thereof, the digital down converter comprising:
means for amplifying a radio frequency signal from an RFID tag;
two means for converting the radio frequency signal to a digital signal representative thereof;
means for providing a clock signal; and
two means for delaying the clock signal, each delay means receiving a clock signal and providing a delayed clock signal to a dedicated one of the two means for converting the radio frequency signal, the two delayed clock signals being offset in time with respect to one another.

15. A method for receiving an RFID signal, the method comprising digitally down converting the RFID signal by undersampling the RFID signal.

16. The method as recited in claim 14, wherein undersampling is performed using at least one analog-to-digital converter.

17. The method as recited in claim 14, wherein undersampling is performed upon a signal from an RFID tag having a frequency of approximately 900 MHz and at a sample rate of approximately 40 MHz.

18. The method as recited in claim 14, wherein undersampling is performed upon a signal from an RFID tag having a frequency of approximately 2.4 GHz and at a sample rate of approximately 40 MHz to 120 MHz.

19. The method as recited in claim 14, wherein undersampling is performed using two analog-to-digital converters that are configured to determine a frequency of the signal from the RFID tag.

20. The method as recited in claim 14, further comprising using two analog-to-digital converters that are configured to determine a frequency of the signal from the RFID tag by determining a slope between adjacent samples, the two analog-to-digital converters performing sampling at times that are between approximately 5 pSec and approximately 100 pSec different from one another.

21. The method as recited in claim 14, further comprising using two analog-to-digital converters that are configured to determine a frequency of the signal from the RFID tag by determining a slope between adjacent samples, the two analog-to-digital converters performing sampling at times that are approximately 5 pSec and approximately 100 pSec different from one another.

22. The method as recited in claim 14, wherein digitally down converting the RFID signal comprises:
amplifying a radio frequency signal received from an RFID tag;
converting the amplified radio frequency signal to a lower frequency signal by undersampling the amplified radio frequency signal; and
and also comprising using at least one of a field programmable gate array (FPGA) and a digital signal processor (DSP) to determine a frequency of the radio frequency signal and to demodulate the radio frequency signal.

23. The method as recited in claim 14, wherein digitally down converting the RFID signal comprises:
amplifying a radio frequency signal received from an RFID tag;
converting the amplified radio frequency signal to a lower frequency signal by undersampling the amplified radio frequency signal with two digital-to-analog converter, the two analog-to-digital converter sampling the amplified radio frequency signal at different times; and
also comprising using at least one of a field programmable gate array (FPGA) and a digital signal processor (DSP) to determine a frequency of the radio frequency signal and to demodulate the radio frequency signal.

24. The method as recited in claim 14, further comprising demodulating the radio frequency signal, the radio frequency signal being modulated using on-off keying (OOK).

25. The method as recited in claim 14, further comprising demodulating the radio frequency signal, the radio frequency signal being modulated using binary phase shift-keying (BPSK) radio frequency signal.
